(19) United States
(12) Patent Application Publication
(10) Pub. No.: US 2019/0005731 A1
(43) Pub. Date: Jan. 3, 2019

(54) PROGRAM EXECUTED ON COMPUTER FOR PROVIDING VIRTUAL SPACE, INFORMATION PROCESSING APPARATUS, AND METHOD OF PROVIDING VIRTUAL SPACE

(71) Applicant: COLOPL, Inc., Tokyo (JP)

(72) Inventors: Seiji SATAKE, Tokyo (JP); Eita KIKUCHI, Tokyo (JP)

(21) Appl. No.: 16/022,768

(22) Filed: Jun. 29, 2018

(30) Foreign Application Priority Data
Jun. 30, 2017 (JP) 2017-129083

(51) Int. Cl. G06T 19/00; G02B 27/01; G06T 7/70; G06T 7/20; G06F 3/01

(52) U.S. Cl. CPC G06T 19/006; G02B 27/0172; G02B 2027/0138; G06T 7/20; G06F 3/017; G06T 7/70

(57) ABSTRACT

A method of providing a virtual space according to at least one embodiment of this disclosure includes defining a first virtual space, wherein the first virtual space comprises a virtual viewpoint and a first camera object. The method further includes defining a first visual field in the virtual space based on a position and posture of the first camera object. The method further includes generating a first visual-field image corresponding to the first visual field. The method further includes displaying the first visual-field image in the first camera object. The method further includes detecting a motion of a first head-mounted device (HMD) associated with a first user. The method further includes defining a second visual field in the virtual space based on the detected motion and a position of the virtual viewpoint in the virtual space, wherein the second visual field comprises the first camera object. The method further includes generating a second visual-field image corresponding to the second visual field. The method further includes displaying the second visual-field image on the HMD.

### TECHNICAL FIELD

This disclosure relates to provision of a virtual space through

use of a head-mounted device, and more particularly, to photography in the virtual space.

### BACKGROUND

There is known a technology of providing a virtual reality space (hereinafter also referred to as “virtual space”) through use of a head-mounted device (hereinafter referred to as “HMD”). In the virtual space, an avatar corresponding to a user of the HMD may be displayed. For example, in Japanese Patent Application Laid-open No. 2017-102639 (Patent Document 1), there is described an “avatar display system capable of selectively revealing motions of a head and line of sight of a user to other users” (refer to “Abstract”)

### PATENT DOCUMENT

[Patent Document 1] JP 2017-102639 A

### SUMMARY

According co one embodiment of this disclosure, there is provided a method of providing a virtual space, the method including defining a first virtual space, the first virtual space including a virtual viewpoint and a first camera object; defining a first visual field in the first virtual space based on a position and posture of the first camera object; generating a first visual-field image corresponding to the first visual field; displaying the first visual-field image in the first camera object; detecting a motion of a first head-mounted device (HMD) associated with a first user; defining a second visual field in the first virtual space based on the detected motion and a position of the virtual viewpoint in the first virtual space, the second visual field including the first camera object; generating a second visual-field image corresponding to the second visual field; and displaying the second visual-field image on the HMD.

The above-mentioned and other objects, features, aspects, and advantages of this disclosure may be made clear from the following detailed description of this disclosure, which is to be understood in association with the attached drawings

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15A A diagram of transition of display of a screen on a monitor 130 according to at least one embodiment of this disclosure.

FIG. 15B A diagram of transition of display of a screen on the monitor 130 according to at least one embodiment of this disclosure.

FIG. 15C A diagram of transition of display of a screen on the monitor 130 according to at least one embodiment of this disclosure.

FIG. 16A to FIG. 16H Diagrams of an image presented on the monitor 130 and a positional relationship between objects in a virtual space 11 at that time according to at least one embodiment of this disclosure.

FIG. 17 A schematic diagram of one mode of storage of data in a storage 630 included in a server 600 according to at least one embodiment of this disclosure.

FIG. 18 A flowchart of a part of processing to be executed by a processor 210 of a computer 200 to acquire positional information and acquired information according to at least one embodiment of this disclosure.

FIG. 19 A flowchart of a part of processing to be executed from adjustment of an angle until photography according to at least one embodiment of this disclosure.

FIG. 20 A flowchart of a part of processing to be executed by the server 600 to provide a recommended photography location according to at least one embodiment of this disclosure.

FIG. 21 A table of an exemplary configuration of content 2181 to be distributed by the server 600 according to at least one embodiment of this disclosure.

FIG. 22 A flowchart of a part of processing to be executed when the computer 200 plays back the content 2181 according to at least one embodiment of this disclosure.

FIG. 23A A diagram of transition of a screen in a case where the monitor 130 presents a recommended photography point according to at least one embodiment of this disclosure.

FIG. 23B A diagram of transition of a screen in a case where the monitor 130 presents a recommended photography point according to at least one embodiment of this disclosure.

FIG. 23C A diagram of transition of a screen in a case where the monitor 130 presents a recommended photography point according to at least one embodiment of this disclosure.

FIG. 23D A diagram of transition of a screen in a case where the monitor 130 presents a recommended photography point according to at least one embodiment of this disclosure.

FIG. 23E A diagram of transition of a screen in a case where the monitor 130 presents a recommended photography point according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

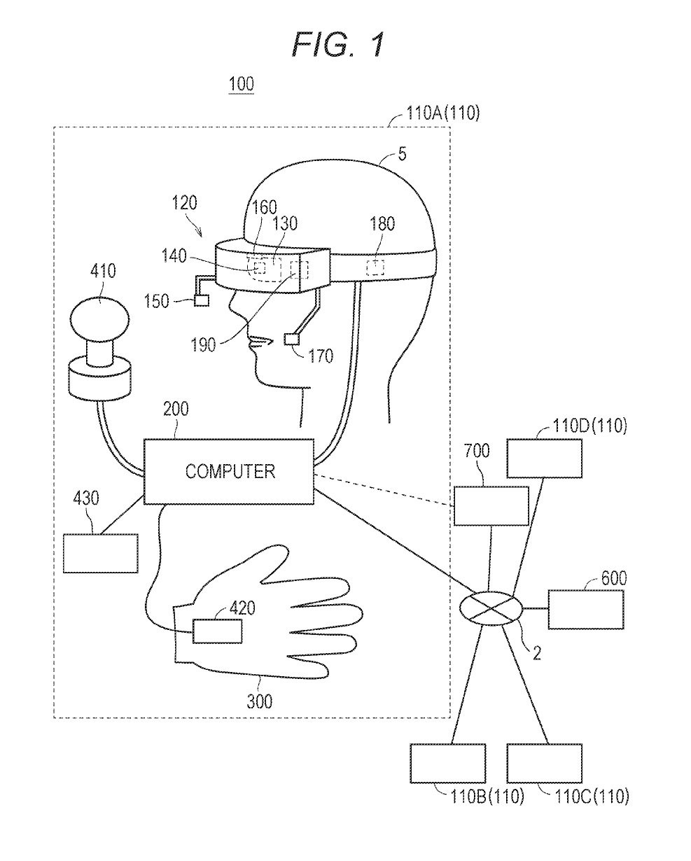

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured so output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the Controller 300. In at least one aspect, the motion sensor 420 is provided to, for example, the controller 300 capable of being held by the user 3. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can al so view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

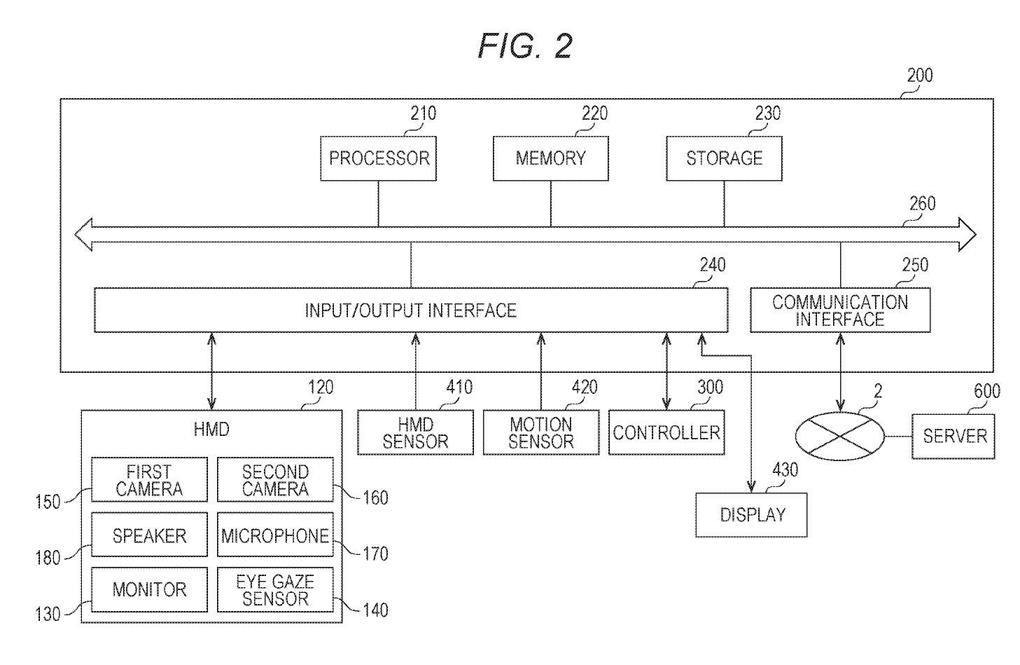

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 80 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

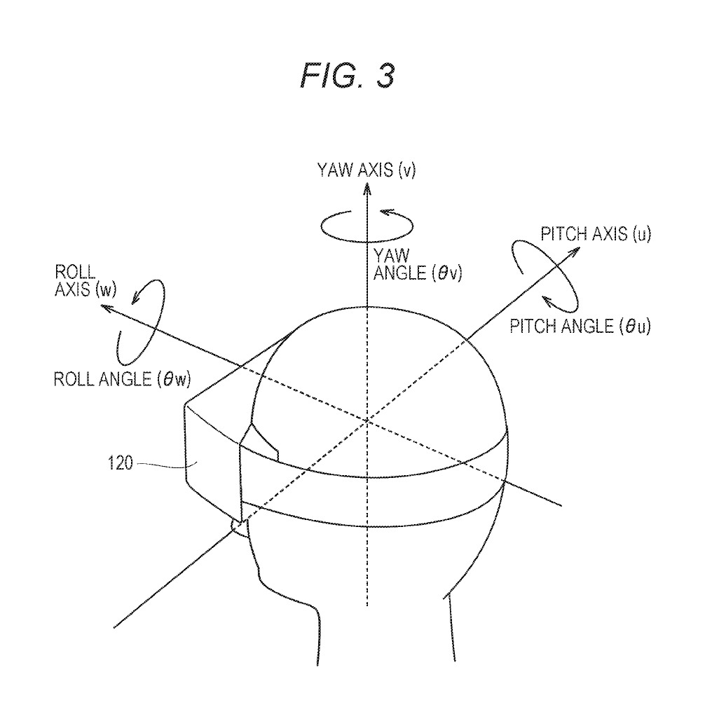

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognzing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system, of the HMD 120 in the real space (real coordinate system) based on the identified relative position.

[Virtual Space]

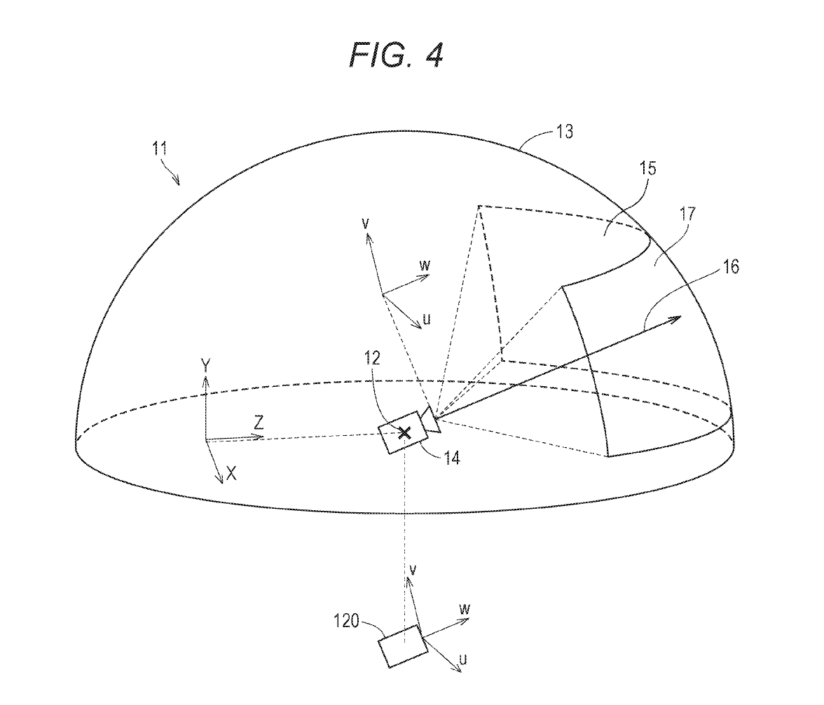

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

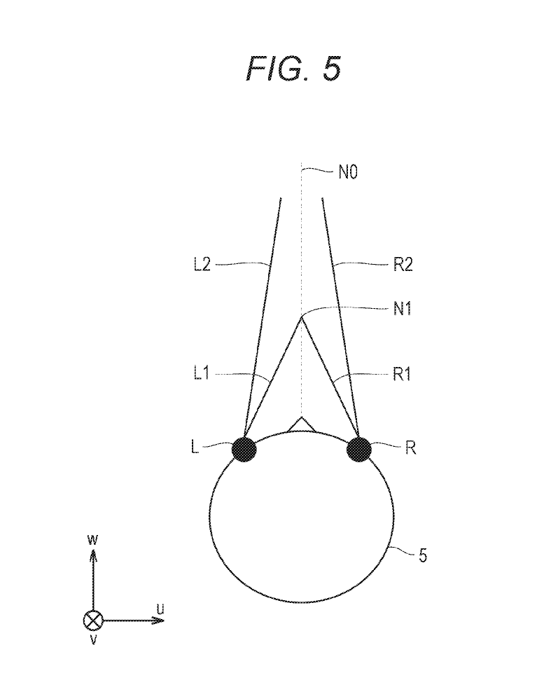

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

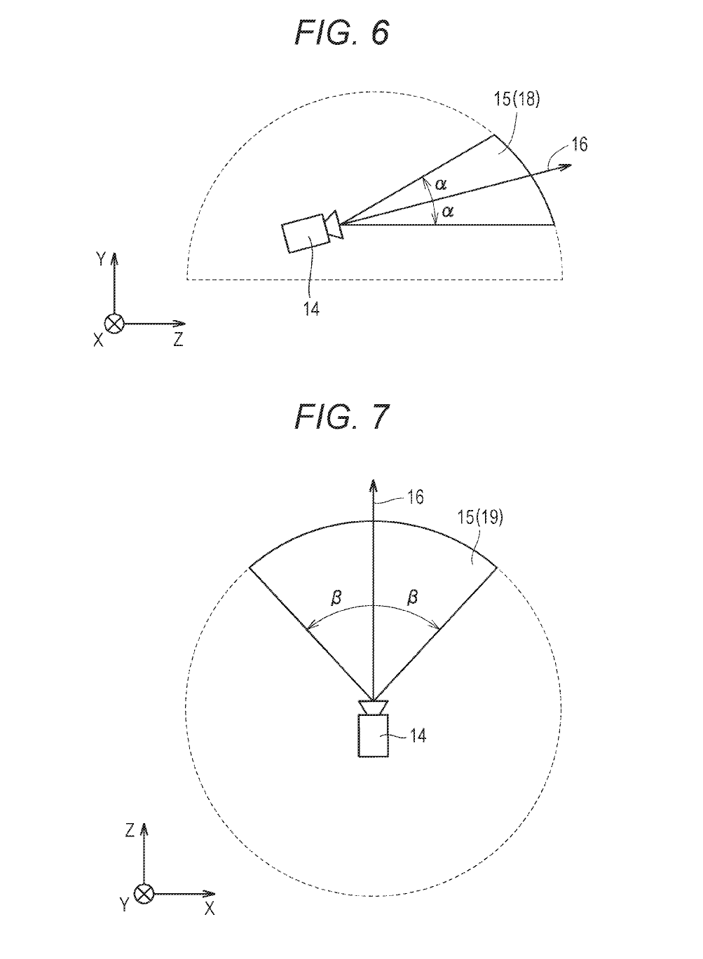

with reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α0 from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

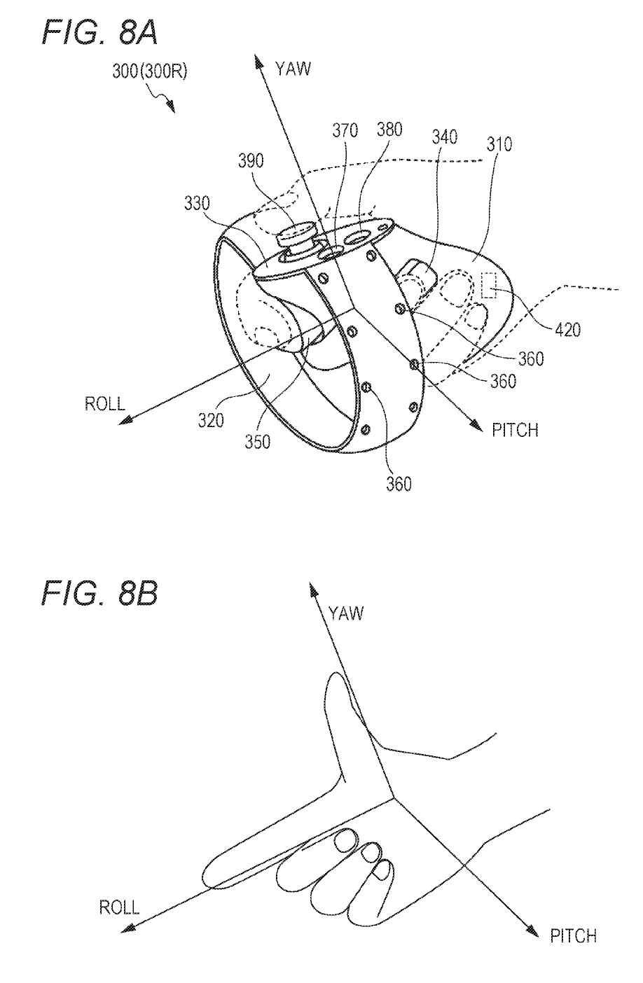

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

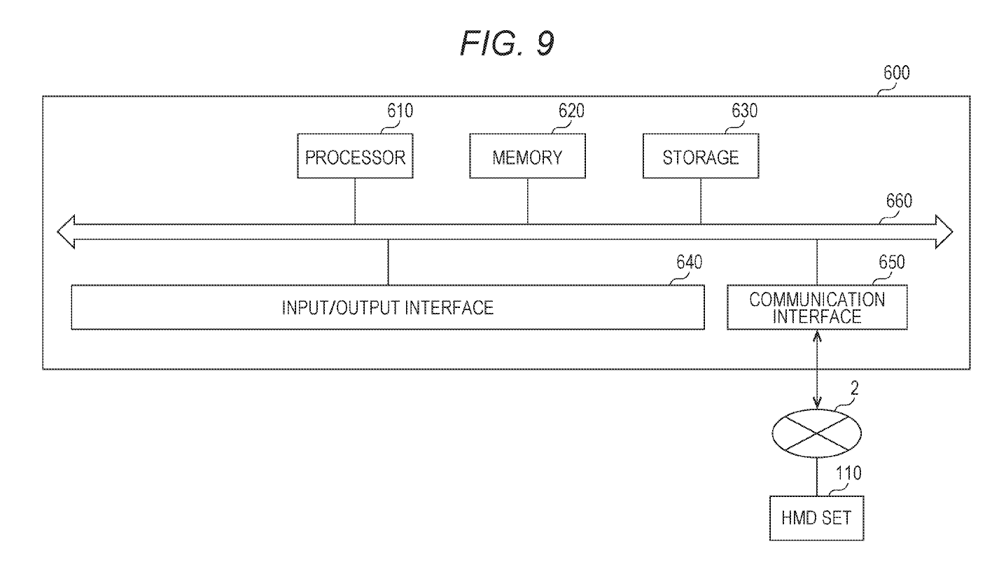

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series or commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

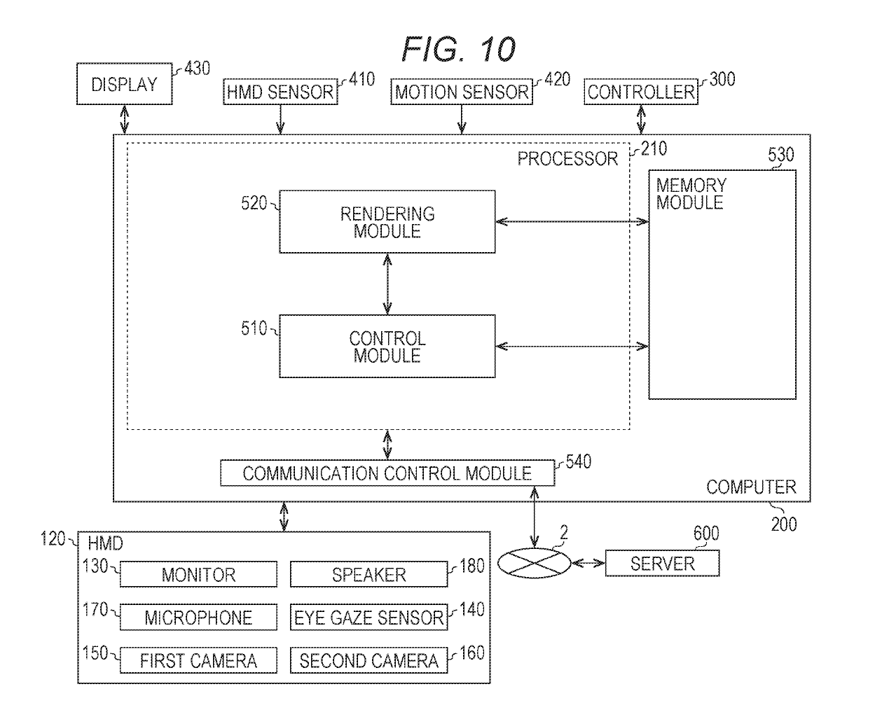

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

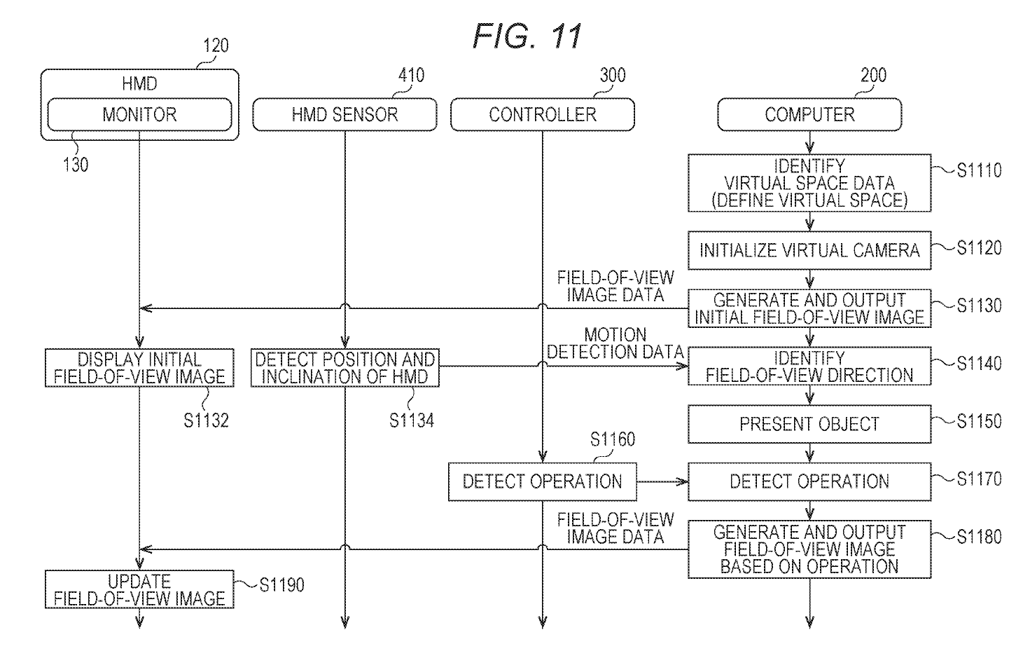

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field of view image data to the HMD 120.

In Step S1190, the HMD 120 updates a field-of-view image based on the received field-of-view image data, and displays the updated field-of-view image on the monitor 130.

[Avatar Object]

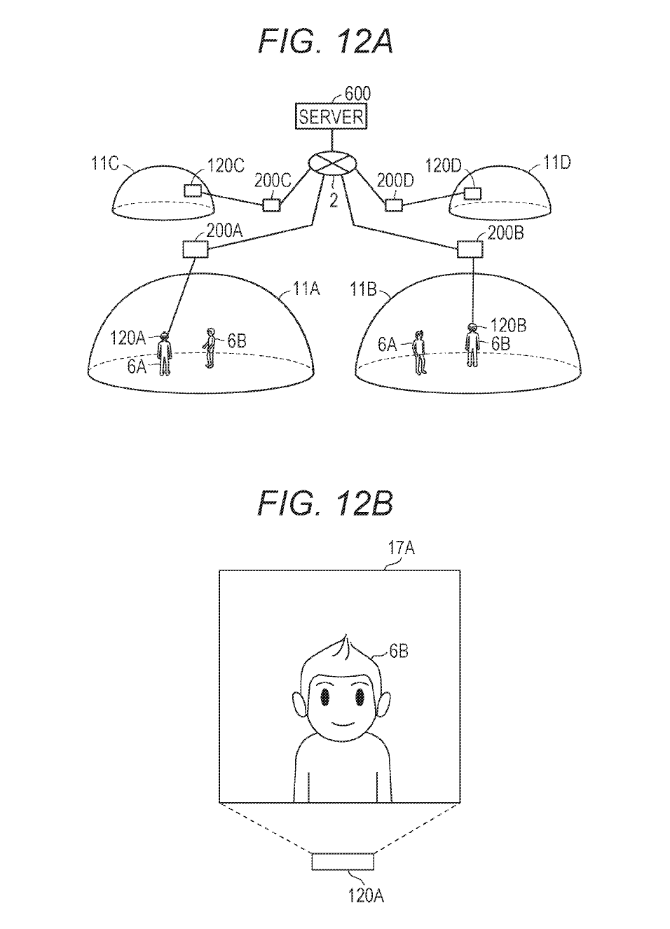

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A, provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

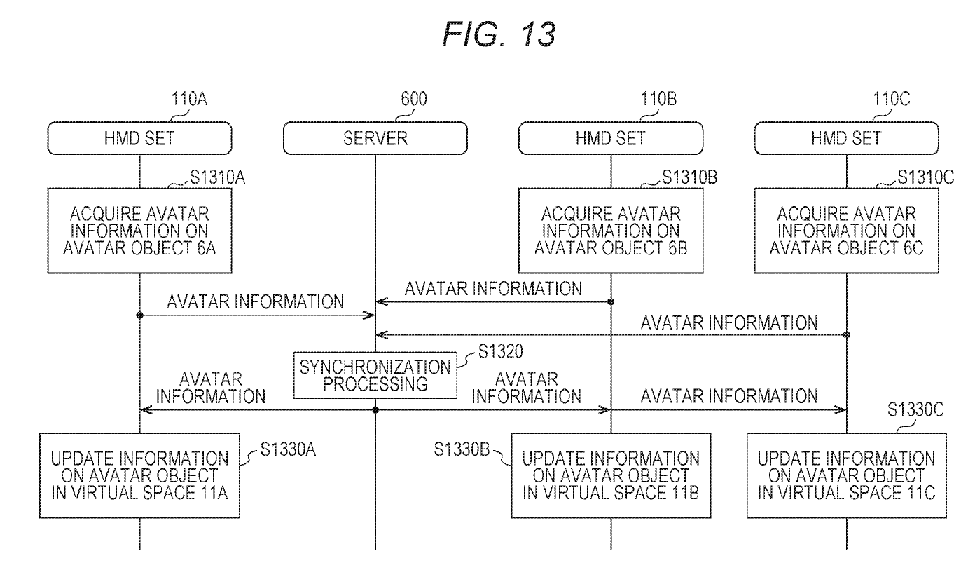

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

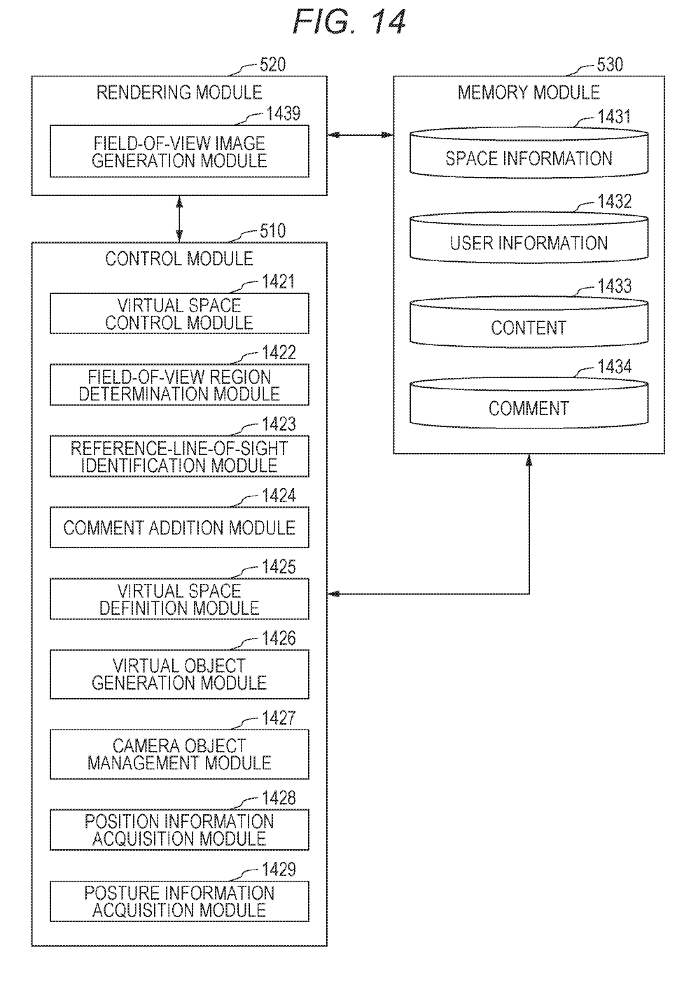

With reference to FIG. 14, details of a module configuration of the computer 200 are described. FIG. 14 is a block diagram of a detailed configuration of modules of the computer 200 according to at least one embodiment of this disclosure. In the following, a description is given of a case of implementing a function of adding a comment by the computer 200. In at least one aspect, this addition function is implemented by the server 600.

In FIG. 14, the control module 510 includes a virtual camera control module 1421, a field-of-view region determination module 1422, a reference-line-of-sight identification module 1423, a comment addition module 1424, a virtual space definition module 1425, a virtual object generation module 1426, a controller management module 1427, position information acquisition module 1428, and posture information acquisition module 1429. The rendering module 520 includes a field-of-view image generation module 1439. The memory module 530 stores space information 1431, user information 1432, content 1433, and a comment 1434.

In at least one aspect, the control module 510 controls image display on the monitor 130 of the HMD 120. The virtual camera control module 1421 arranges the virtual camera 14 in the virtual space 11, and controls the behavior, direction, and the like of the virtual camera 14. The field-of-view region determination module 1422 defines the field-of-view region 15 in accordance with the direction of the head of the user wearing the HMD 120. The field-of-view image generation module 1439 generates, based on the determined field-of-view region 15, a field-of-view image 17 to be displayed on the monitor 130.

The reference-line-of-sight identification module 1423 identifies the line of sight of the user 5 based on the signal from the eye gaze sensor 140. The comment addition module 1424 superimposes the comment received via the server 600 onto the field-of-view image generated by the field-of-view image generation module 1439.

The position information acquisition module 1428 acquires position information on the camera object 1541 in the virtual space 11. The position information is represented based on coordinate axes of the virtual space 11 illustrated in FIG. 4, for example.

The posture information acquisition module 1429 acquires posture information on the camera object 1541 in the virtual space 11. The posture information contains a photography direction of the camera object 1541. In at least one aspect, the posture information is represented as vector information on the camera object 1541 in the virtual space 11.

The control module 510 controls the virtual space 11 provided to the user 5. The virtual space definition module 1425 defines the virtual space 11 in the HMD system 100 by generating virtual space data representing the virtual space 11. The virtual object generation module 1426 generates a target object to be arranged in the virtual space 11. Examples of the target object include an object constructing a mountain, a tree, a building, or other background, an animal object and the like to be presented in accordance with the story in the program implemented by the computer 200.

The controller management module 1427 receives the motion of the user 5 in the virtual space 11 and controls the controller object in accordance with the motion. The controller object in at least one embodiment functions as a controller configured to issue instructions to other objects arranged in the virtual space 11. In at least one aspect, the controller management module 1427 generates data for arranging in the virtual space 11 a controller object for receiving control in the virtual space 11. When the HMD 120 receives this data, the monitor 130 may display the controller object.

The space information 1431 stores one or more templates defined in order to provide the virtual space 11. The user information 1432 includes identification information on the user 5 of the HMD 120, an authority associated with the user 5, and the like. The authority includes, for example, account information (user identification (ID) and password) for accessing a website providing an application. The content 1433 includes, for example, content to be presented by the HMD 120. The comment 1434 is a comment input by another user using any one of the HMD set 110A to the HMD set 110D.

First, a description is given of a difference between the real space and the virtual space regarding photography. In the real space, the following point may be recognized. A photographer desires to take as many photographs as possible. At the same time, the photographer considers it a bother to extend or close a selfie stick every time. The photographer often does not have information on where to take photographs or know a place appropriate for photography, resulting in a possibility of missing a photography timing. As a result, the photographer may leave the selfie stick extended.

Meanwhile, in the virtual space, which is provided through use of an HMD, the photographer is required to view preview display at the time of photography through a monitor of the HMD, for example, a monitor of a smartphone equipped with a camera and mounted on the HMD, in order to check whether a photography angle is appropriate. In this case, there is no system for proposing a photography location unlike the case of the real world, for example, “This is a good place to take photographs”.

When a photographer takes a selfie, the photographer is required to view preview display on the smartphone as means for checking whether the photographer is shown at an appropriate position. In the case of the real world, there may be such proposition or display as “This is a good position to stand at to take photographs”. However, in the case of the virtual space, there is no such proposition or display.

Regarding a line of sight of a user, when the user takes photographs by using a so-called front-facing camera of the smartphone, the user often looks at a monitor screen of the smartphone as a subject. As a result, in particular, when the size of the monitor screen is large, the line of sight of the user is directed more toward the monitor screen than toward the camera, and thus the user is less likely to look at the camera.

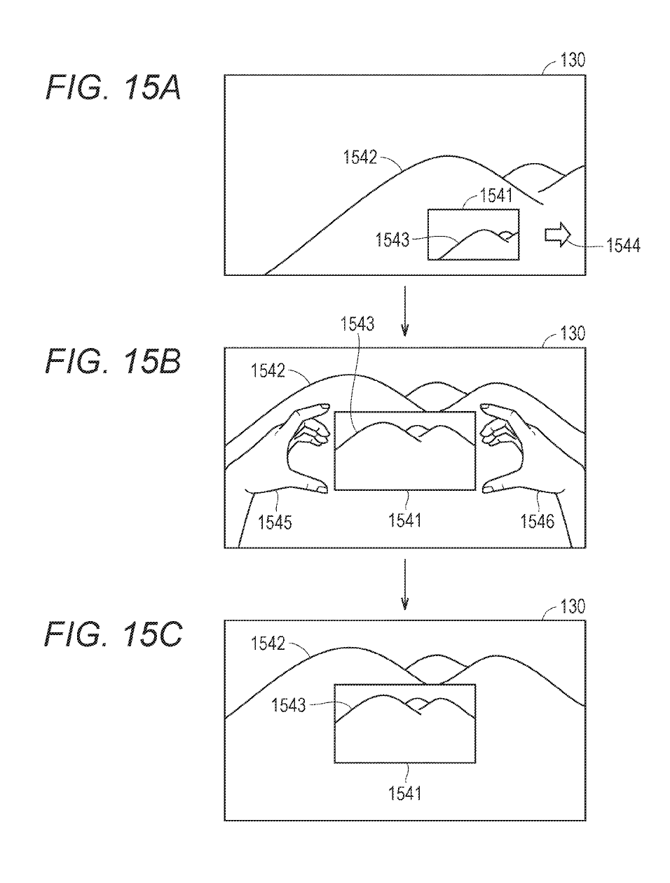

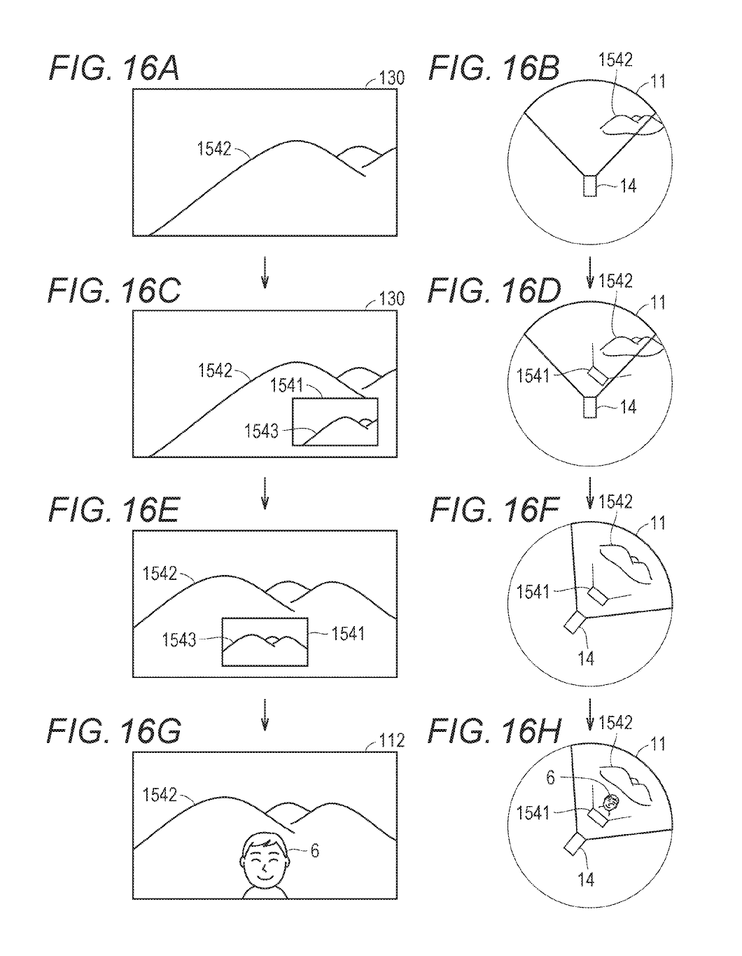

In view of the above, a description is now given of a technical spirit of this disclosure with reference to FIG. 15A to FIG. 15C and FIG. 16A to FIG. 16H. FIG. 5 is a diagram of transition of display on the screen of the monitor 130 according to at least one embodiment of this disclosure.

In FIG. 15A, in at least one aspect, the monitor 130 displays an object 1542. Further, the monitor 130 also displays a camera object 1541 in the virtual space. The camera object 1541 displays a monitor image 1543 corresponding to the object 1542. In at least one aspect, the monitor 130 further displays an arrow 1544 for inducing the camera object 1541 to move in an appropriate direction. When the user moves the camera object 1541 along the arrow 1544, the object 1542 can be captured in a photography range more preferably.

Specifically, in FIG. 15B, a left hand object 1545 and a right hand object 1546 corresponding to hands of the user are displayed on the monitor 130. The user uses the left hand object 1545 and the right hand object 1546 to adjust the position and photography direction of the camera object 1541 in the virtual space. When it is confirmed that a monitor image of the object 1542 is displayed on the camera object 1541, the position is recorded as a position for photography.

Thus, in FIG. 15C, even after the left hand object 1545 and the right hand object 1546 are no longer displayed in the virtual space, the posture of the camera object 1541 is kept in a state preferable for photographing the object 1542.

FIG. 16A to FIG. 16H are diagrams of an image presented on the monitor 130 and a positional relationship between objects in the virtual space 11 at that time according to at least one embodiment of this disclosure. Referring to FIG. 16A to FIG. 16H, in FIG. 16A, the monitor 130 displays the object 1542. At this time, a positional relationship between the virtual camera 14 and the object 1542 in the virtual space 11 is illustrated in such a manner as in FIG. 16B.

When a predetermined condition for displaying the camera object 1541 in the virtual space 11 is satisfied, in FIG. 16C, the camera object 1541 is displayed at a predetermined position on the monitor 130. For example, the camera object 1541 may be arranged at the center of the monitor 130 so as to be able to be grasped by both hands. At this time, the positional relationship between the virtual camera 14 and the object 1542 in the virtual space 11 is illustrated in such a manner as in FIG. 16D.

After that, when the user adjusts the position of the camera object 1541 in the virtual space 11, in FIG. 16E, the monitor image 1543 based on the adjusted arrangement is displayed on the camera object 1541. At this time, the positional relationship between the virtual camera 14 and the object 1542 in the virtual space 11 is illustrated in such a manner as FIG. 16F. When the user establishes this arrangement as the photography angle, an identification number for identifying this arrangement and position information representing this arrangement are stored in a server and other computers providing the virtual space 11. Therefore, in a case of displaying the same object at another timing, the same photography angle may be reproduced easily through specification of the identification number.

Further, when the user selects a selfie mode in the virtual space 11, in FIG. 16G, the avatar object 6 of the user registered in advance is presented on the monitor 130. At this time, the positional relationship between the camera object 1541 and the avatar object 6 in the virtual space 11 is illustrated in such a manner as in FIG. 16H.

[Outline of Configuration]

In at least one embodiment, the processor 210 defines the virtual space 11 to be presented on the HMD 120 connected to the computer 200. The processor 210 presents, in the virtual space 11, the camera object 1541 for photographing an image to be displayed in the virtual space 11. The processor 210 receives, from the controller 300, an operation for changing the position or posture of the camera object 1541 by the user 5 of the HMD 120. The processor 210 stores position information representing the position or posture information representing the posture into the memory 220. The processor 210 transmits the position information or posture information to the server 600. With this, the photography point and photography direction in the virtual space 11 may be shared in the form of the position information and photography direction.

In at least one embodiment, the processor 210 presents the camera object 1541 based on an operation by the user 5 of the HMD 120. With this, the user 5 can take photographs as desired by using the camera object 1541.

In at least one embodiment, the processor 210 presents a user interface object for receiving input of a comment by the user 5 in the virtual space 11. When the user 5 inputs a comment, the comment may be stored in the server 600. With this, feedbacks and other impressions of the photography point may also be shared with other users.

In at least one embodiment, the image contains a plurality of frames. Tag information for inducing photography is associated with any one of the plurality of frames. When the frame with which the tag information is associated is presented in the virtual space 11, the processor 210 presents the camera object 1541. When the tag information is detected, the camera object 1541 is displayed. As a result, the user 5 can easily recognize a recommended photography timing, and is less likely to miss a photography chance.

In at least one embodiment, the tag information contains any one of information created in advance at the time of creation of an image and information associated with an image based on photography by the user 5 who has viewed the image. With this, a photography timing recommended by the creator of content may be notified to a viewer through use of the tag information. A location at which the viewer has newly taken a photograph can be added to the tag information, and thus a photography point from a viewpoint that is not intended by the creator of content may also be newly shared among users.

In at least one embodiment, the processor 210 takes photographs by the camera object 1541 when the posture of the camera object 1541 has continued for a fixed period of time. With this, automatic photography is enabled.

In at least one embodiment, the processor 210 arranges an avatar object of the user 5 in the virtual space 11, and the camera object 1541 photographs the avatar object. With this, the photographer can take a so-called “selfie” in the virtual space 11.

In at least one embodiment, the processor 210 stores position information and posture information on the camera object 1541 at the time of photography of the avatar object. The processor 210 may store the position information representing the position of the avatar object and the posture information representing the direction of the avatar object. With this, information (position information and posture information) on the location and angle of a selfie may also be shared with other users.

In at least one embodiment, the processor 210 stores identification data on photographed content and one or more combinations of position information and posture information. With this, the position information and posture information may be provided to other users viewing the same content.

In at least one embodiment, when the camera object 1541 is not presented in the virtual space 11, the processor 210 presents the camera object 1541 in the virtual space 11. When the user 5 visually recognizes the camera object 1541, the user 5 can easily recognize arrival of a photography chance.

In at least one embodiment, the processor 210 presents the camera object 1541 of the user 5 of the HMD 120 based on the position information and posture information on camera objects used by other users sharing the virtual space 11. For example, the server 600 may notify the computer 200 of the position information and posture information based on recommendation by other users who have viewed the same content, and thus the user 5 can take photographs at a photography location popular with other users.

In at least one embodiment, the processor 210 presents a hand object corresponding to a hand of the user 5 in the virtual space 11. The processor 210 adjusts the position and posture of the camera object 1541 in accordance with a motion of the hand object that is based on an operation or motion of the user 5. After the posture of the camera object 1541 is kept for a fixed period of time, the processor 210 may keep the posture of the camera object 1541 even when the hand object has separated from the camera object 1541. With this, a camera shake in the virtual space 11 is prevented. The user 5 may adjust the own position in the virtual space 11 to take a selfie while keeping establishment of the photography angle.

[Data Structure]

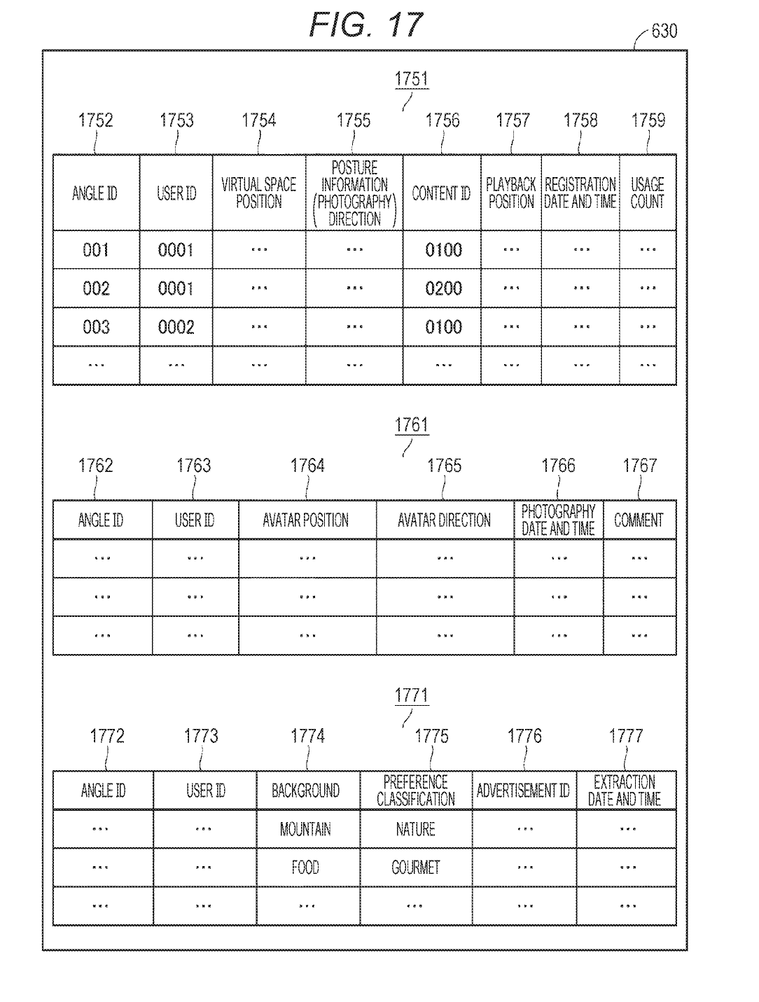

Now, a description is given of a data structure of the server 600 with reference to FIG. 17. FIG. 17 is a schematic diagram of one mode of storage of data in the storage 630 included in the server 600 according to at least one embodiment of this disclosure. In at least one aspect, the storage 630 stores tables 1751, 1761, and 1771.

The table 1751 serves as a database of photography points. More specifically, in at least one aspect, the table 1751 contains an angle ID 1752, a user ID 1753, a virtual space position 1754, posture information (photography direction) 1755, a content ID 1756, a playback position 1757, a registration date and time 1758, and a usage count 1759.

The angle ID 1752 identifies an angle of the camera object 1541 in the virtual space 11. The angle ID 1752 is automatically assigned by the processor 610 configured to execute an instruction based on an operation of establishing a photography position in the virtual space 11 by each user. The user ID 1753 identifies the user 5 who has requested registration of the photography position. The virtual space position 1754 represents the position information in the virtual space 11. The position information is represented based on, for example, the uvw visual-field coordinate system. The posture information 1755 represents a photography direction in which the camera object 1541 faces. The posture information 1755 is represented as, for example, vector information having the virtual space position 1754 as its start point. The content ID 1756 identifies content photographed through use of the camera object 1541. The playback position 1757 represents a time stamp at which the content was photographed. When the content is a moving image, the moving image is displayed in the virtual space 11. The playback position 1757 may identify one frame photographed in the moving image. The registration date and time 1758 represents a date and time at which the angle identified by the angle ID 1752 was stored by the user 5. The usage count 1759 represents the number of times the angle was used.

The table 1761 stores a usage history of angle information. More specifically, in at least one aspect, the table 1761 contains an angle ID 1762, a user ID 1763, an avatar position 1764, an avatar direction 1765, a photography date and time 1766, and a comment 1767.

The angle ID 1762 identifies a used angle. The user ID 1763 identifies a user of the angle identified by the angle ID 1762. The angle registered in the table 1751 can be used by one or more users. Therefore, the user ID 1763 may contain user IDs of various users. The avatar position 1764 represents a position at which an avatar object corresponding to a user who has used the angle is arranged. The avatar direction 1765 represents a direction in which the avatar object faces forward. The direction may be represented as, for example, vector information having the avatar position 1764 as its start point. The photography date and time 1766 represents a date and time at which a photograph was taken through use of the angle. The comment 1767 represents a comment input by the user who has used the angle.

The table 1771 stores a database of a background extracted by the processor 610 from an image photographed at each angle. The table 1771 contains an angle ID 1772, a user ID 1773, a background 1774, a preference classification 1775, an advertisement ID 1776, and an extraction date and time 1777.

The angle ID 1772 identifies an angle at which the background was extracted. The user ID 1773 identifies a user photographed as an avatar object through use of the angle. The background 1774 identifies a background extracted from an image photographed at the angle. The identified background is defined in advance. The background to be extracted is identified based on, for example, a name associated with an image containing the background or a name of the background associated with geographical coordinate values in the real space when the background is extracted from an image imitating the background in the real space. The preference classification 1775 represents a classification associated with the extracted background 1774 in advance or a preference input at the time of registration of user information by the user. The advertisement ID 1176 identifies an advertisement that may be distributed to a user identified by the user ID based on an extraction result (background 1774). The extraction date and time 1777 represents a date and time at which the background 1774 was extracted.

[Control Structure]

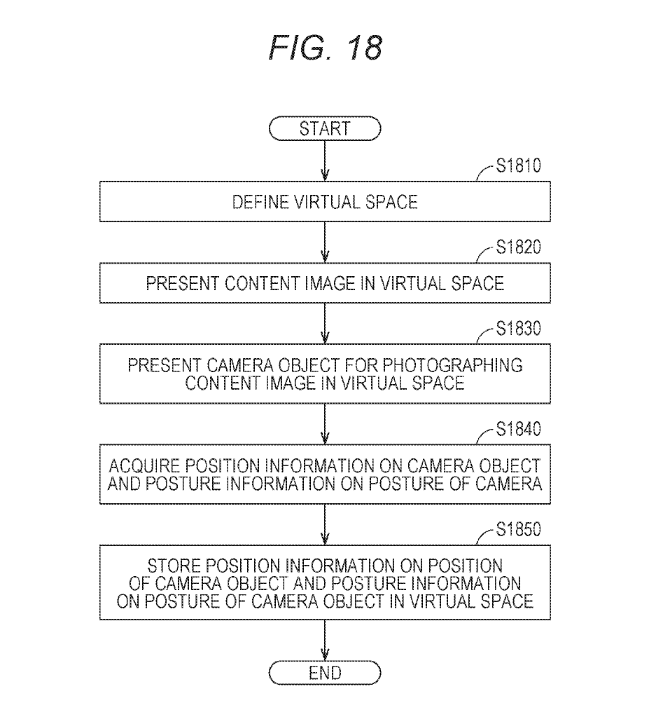

Now, a description is given of a control structure of the computer 200 with reference to FIG. 18. FIG. 18 is a flowchart of a part of processing to be executed by the processor 210 of the computer 200 to acquire positional information and acquired information according to at least one embodiment of this disclosure. In at least one aspect, each processing is implemented by a circuit element configured to execute each processing. In at least one aspect, when the HMD 120 includes a processor, the processor executes the processing.

In Step S1810, the processor 210 executes an application program for providing content to a virtual reality space to define the virtual space 11. The content may contain, for example, any one of content that uses an image obtained by photographing the real space, and animations and other content that draw the virtual reality world.

In Step S1820, the processor 210 presents a content image in the virtual space 11. When visually recognizing the monitor 130, the user 5 wearing the HMD 120 may recognize the content image.

In Step S1830, the processor 210 presents the camera object 1541 for photographing the content image in the virtual space 11. Presentation of the camera object 1541 is triggered when, for example, the user 5 gives an instruction to present the camera object 1541, other users who have viewed the content image before recommend a part (e.g., one scene or view from a certain position) of the content image through comments or other input, or a creator or provider of the content image recommends presentation of the camera object 1541 in advance. An operation mode selected by the user 5 defines which of the triggers is effective. A location at which the camera object 1541 is to be presented may be any one of a location defined in advance as an initial position and a location recommended by another user. After the camera object 1541 is presented, the user 5 may further change the position of the camera object 1541 in the virtual space 11 by using the controller 300.

In Step S1840, the processor 210 acquires the position information on the camera object 1541 and the posture information representing the posture of the camera object 1541. The position information to be acquired is an initial position of the camera object 1541 or, when the position is changed by the user 5, position information on the changed position. The posture information to be acquired is posture information (photography direction) that depends on a posture defined in advance at the initial position of the camera object 1541 or, when the posture is changed by an operation. of the controller 300, posture information that depends on the changed posture.

In Step S1850, the processor 210 stores the position information representing the position of the camera object 1541 and the posture information representing the posture of the camera object in the virtual space 11 based on an operation by the user 5. For example, when the user 5 has changed the position or posture of the camera object 1541, and the user 5 has given an instruction to store the changed position information or posture information, the position information or posture information is transmitted from the computer 200 to the server 600 together with the user ID of the user 5, and the content ID and registration date and time of the played back content.

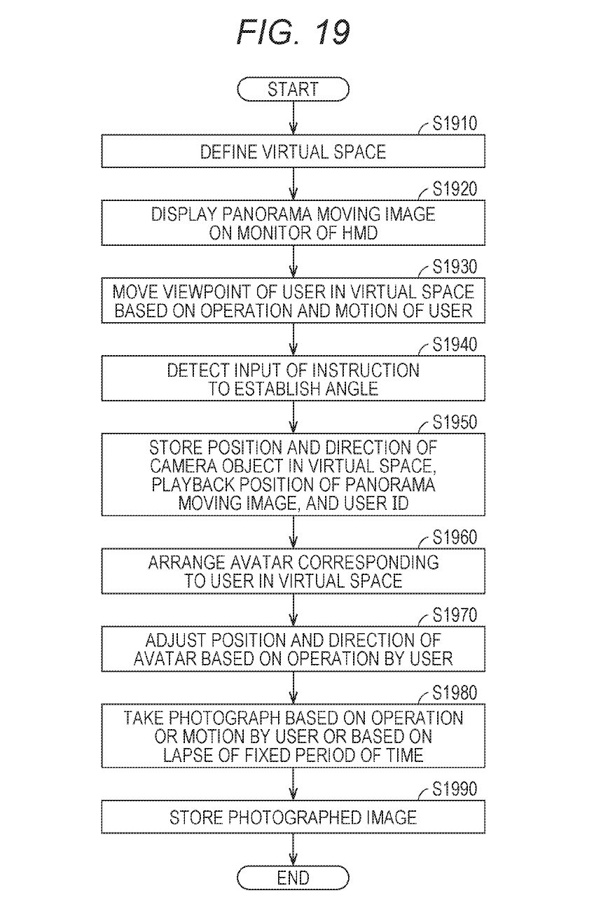

Now, a description is further given of a control structure of the computer 200 with reference to FIG. 19. FIG. 19 is a flowchart of a part of processing to be executed from angle adjustment until photography. The following processing is started when, for example, the user 5 selects a panorama moving image as content and gives an instruction to play back the panorama moving image to the controller 300.

In Step S1910, the processor 210 defines the virtual space 11 similarly to Step S1810. In Step S1920, the processor 210 displays a panorama moving image on the monitor 130 of the HMD 120.

In Step S1930, the processor 210 moves the viewpoint of the user 5 in the virtual space 11 based on an operation of the controller 300 by the user 5 and a motion of the user 5, for example, movement of the head wearing the HMD 120.

In Step S1940, the processor 210 detects input of an instruction to establish an angle for taking a photograph in the virtual space 11 based on an operation of the controller 300 by the user 5. For example, when the user 5 visually recognizes a scene of the image presented on the monitor 130 and desires to photograph the image, the user 5 operates the controller 300 to perform an input operation for registering the scene as the photography location.

In Step S1950, the processor 210 stores into the memory 220 the position and direction of the camera object in the virtual space 11, the playback position of the panorama moving image, and the user ID. Further, the processor 210 transmits to the server 600 the position information that is based on the position and the posture information that is based on the direction, the playback position, the user ID, the content ID, and registration time data. The server 600 stores those pieces of data received from the computer 200 into the table 1751 of the storage 630. The angle ID 1752 is newly assigned, and a data record containing the user ID 1753, the virtual space position 1754, the posture information 1755, and the content ID 1756 based on the received pieces of data is added to the table 1751.

In Step S1960, the processor 210 arranges an avatar object corresponding to the user 5 in the virtual space 11. For example, when the photography position and posture information in one scene of the panorama moving image are registered, the avatar object corresponding to the user 5 is arranged against a background of the scene. In this case, the avatar object takes a selfie against the background of the scene from the viewpoint of the avatar object.

In Step S1970, the processor 210 adjusts the position and direction of the avatar object based on an operation of the controller 300 by the user 5.

In Step S1980, the processor 210 takes a photograph through use of the camera object 1541 based on an operation or motion of the controller 300 by the user 5 or based on a lapse of a fixed period of time determined in advance. The motion of the user 5 may contain, for example, gazing at a location (e.g., camera object 1541) specified in advance in an image presented on the monitor 130 or avoiding blinking for a predetermined period of time.

In Step S1990 the processor 210 stores the photographed image into the memory 220. Further, the computer 200 transmits information at the time of photography to the server 600. The server 600 stores the received information into the storage 630 (table 1761). The information contains, for example, the user ID, the position of the avatar object, the direction of the avatar object, and the photography date and time. Further, when the user 5 has input a comment, the computer 200 transmits the comment to the server 600. The server 600 stores the received comment into the table 1761 as the comment 1767.

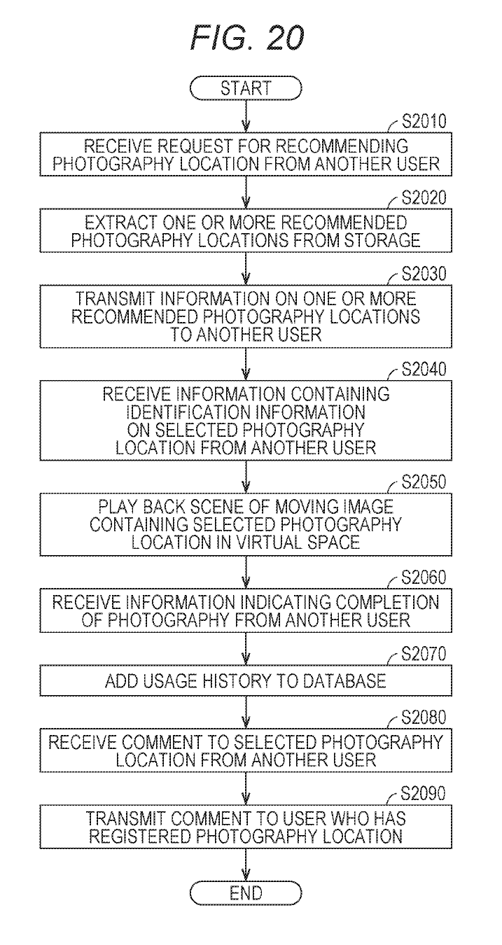

Now, a description is given of a control structure of the server 600 with reference to FIG. 20. FIG. 20 is a flowchart of a part of processing to be executed by the server 600 to provide a recommended photography location according to at least one embodiment of this disclosure.

In Step S2010, the processor 610 of the server 600 receives a request for recommending a photography location from another user. For example, when the user of the HMD set 110B selects an icon for requesting a recommended photography location in the virtual space 11 presented on the HMD 120, the request is transmitted from a computer (not shown) connected to the HMD set 110B to the server 600.

In Step S2020, the processor 610 extracts one or more recommended photography locations from the storage 630 based on reception of the request. The recommended photography location may be extracted based on, for example, the angle ID 1752 with the highest usage count 1759, the angle ID 1762 for which the comment 1767 contains a recommend message, or the preference classification 1775 that matches a preference registered in advance as user information on another user.

In Step S2030, the processor 610 transmits information on one or more recommended photography locations to a computer to which another use is connected. The information may contain the angle ID 1752, the virtual space position 1754, the posture information 1755, and the content ID 1756. When another user has received one or more combinations of pieces of information, another user may select any one from among the one or more combinations of pieces of information. When photography information is provided to another user for each of a plurality of pieces of content, another user may select any one of the plurality of pieces of content.

In Step S2040, the processor 610 receives information containing identification information on the photography location selected by another user from another user. The received information contains the user ID, the content ID 1756, and the angle ID 1752 of another user.

In Step S2050, the processor 610 plays back the scene of a moving image containing the selected photography location in the virtual space 11 provided to the HMD set 110B via a computer to which another user is connected. When another user visually recognizes the monitor (not shown) of the HMD set 110B, another user can visually recognize the selected content. Another user may execute a photography operation in the virtual space 11 at the recommended photography location in the content. More specifically, another user views content based on the received information, and takes a photograph at the recommended photography location as a landscape image or takes a selfie by presenting the own avatar object in the virtual space 11. When another user operates the HMD set 110B to take a photograph in the virtual space 11, information indicating completion of the photography is transmitted to the server 600.

In Step S2060, the processor 610 receives the information indicating completion of the photography from a computer to which a user terminal 201A used by another user is connected. In at least one aspect, the information contains the user ID, the content ID, the angle ID, and the photography date and time. In at least one aspect, the information may further contain the position and direction of the avatar.

In Step S2070, the processor 610 adds a usage history to the database based on the received data (table 1761).

In Step S2080, the processor 610 receives a comment to the selected photography location from another user. The processor 610 updates the comment 1767 of the table 1761 with the received comment.

In Step S2090, the processor 610 transmits the comment to a user who has registered the photography location. For example, the processor 610 transmits the comment to an account of a user that is registered to receive content. In at least one aspect, the processor 610 updates the usage count 1759 of the table 1751 when another user has used the photography location registered by the user.

[Data Structure]

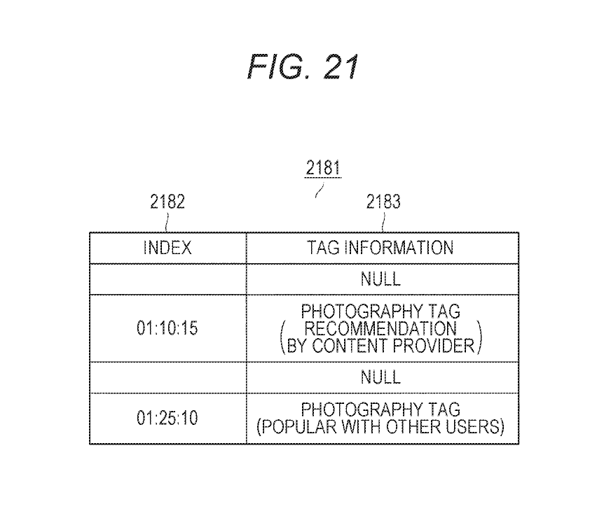

Now, a description is given of a data structure of content with reference to FIG. 21. FIG. 21 is a table of an exemplary configuration of content 2181 to be distributed by the server 600 according to at least one embodiment of this disclosure. The content 2181 contains an index 2182 and tag information 2183.

The index 2182 represents a location measured with respect to a start position of playback in the content 2181. The location is indicated by, for example, an elapsed period of time in a case where a start time is set to 0. In at least one aspect, the index 2182 corresponds to the playback position 1757. The tag information 2183 is information allocated to each position in the content 2181.

For example, in the example of the content 2181, a photography tag “recommendation by content provider” is associated with an index “01:10:15” indicating that 1 hour, 10 minutes, and 15 seconds have elapsed from the head. When the processor 610 of the server 600 detects this index at the time of distribution of the content 2181, the processor 610 may detect that the photography tag is associated with this index, and notify a viewer (e.g., above-mentioned another user) of the content 2181 of the fact that this scene is recommended by the provider. When the processor 610 detects an index “01:25:10”, the processor 610 detects that a photography tag is associated with this index, and notifies the viewer of the content 2181 of the fact that this scene is popular with other users. The viewer of the content (e.g., user 5) can know a recommendation in the viewed content based on such a notification.

[Control Structure]

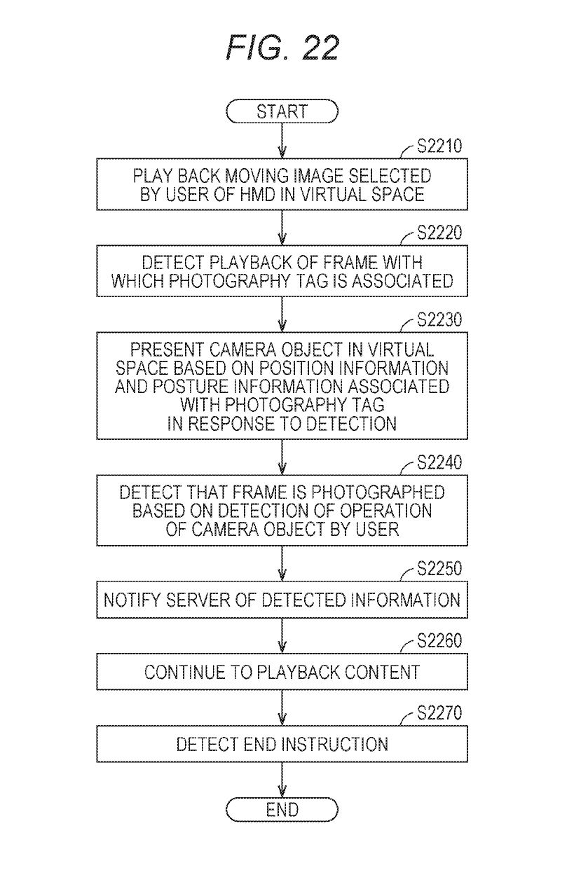

Now, a description is given a control structure of the computer 200 with reference to FIG. 22. FIG. 22 is a flowchart of a part of processing to be executed when the computer 200 plays back the content 2181 according to at least one embodiment of this disclosure.

In Step S2210, the processor 210 plays back a moving image (content 2181) selected by the user 5 of the HMD 120 in the virtual space 11. More specifically, first, the computer 200 receives data on content selected by the user 5 from the server 600. The processor 210 converts the data into a format that fits display on the HMD 120, and transmits the converted data to the HMD 120. The monitor 130 of the HMD 120 presents a moving image of the content in the virtual space 11 based on the data.

In Step S2220, the processor 210 detects playback of a frame with which the photography tag is associated based on detection of the index 2182.

In Step S2230, in response to the detection, the processor 210 presents the camera object 1541 in the virtual space 11 based on the position information (virtual space position 1754) and the posture information 1755 associated with the photography tag.

In Step S2240, the processor 210 detects that the frame is photographed based on detection of an operation of the camera object 1541 by the user. For example, when the user 5 operates the controller 300 in a predetermined manner to photograph the frame, a signal corresponding to the operation is input to the processor 210, and the processor 210 detects that the frame is photographed.

In Step S2250, the processor 210 notifies the server 600 of the detected information. Information to be notified to the server 600 contains the user ID, the content ID, the position information and posture information in the virtual space, and the photography date and time. When the user 5 has taken a selfie in the virtual space 11, the information may further contain the avatar position 1764 and the avatar direction 1765.

In Step S2260, the processor 210 continues to playback the content. After that, when another index is detected, Step S2220 and its subsequent processing steps are repeated.

In Step S2270, the processor 210 detects an end instruction. For example, the processor 210 ends playback based on detection of an end point of the content 2181 or input of an instruction to forcibly end the content 2181 by the server 600 or the user 5 during playback thereof.

[Display Mode of Screen]

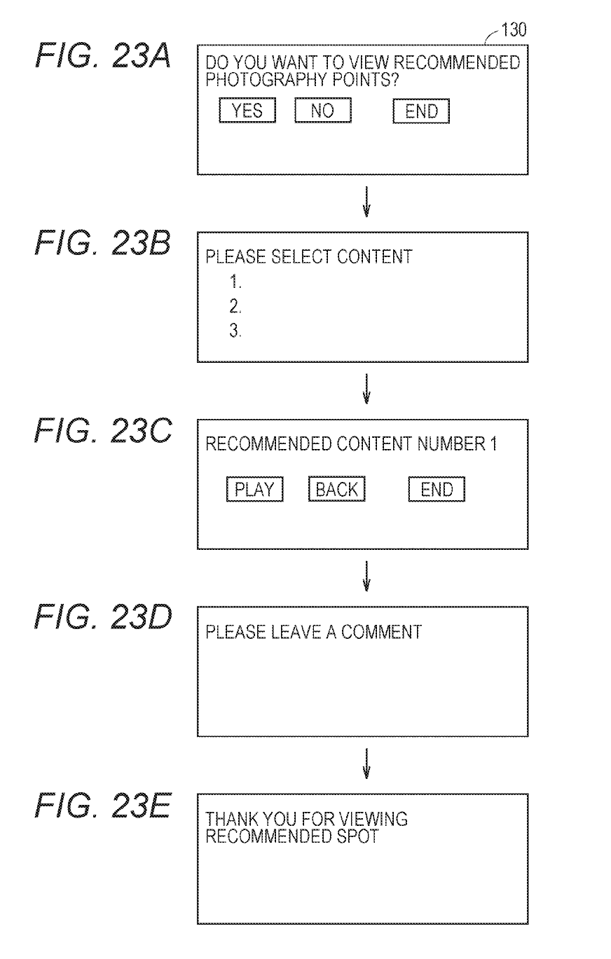

Now, a description is given of a display mode of the screen on the monitor 130 with reference to FIG. 23A to FIG. 23E. FIG. 23A to FIG. 23E are diagrams of transition of the screen in a case where the monitor 130 presents a recommended photography point according to at least one embodiment of this disclosure. The following screen is displayed when, for example, the user 5 wearing the HMD 120 operates the controller 300 and accesses the server 600 for providing content.

In FIG, 23A, in at least one aspect, the monitor 130 displays a message indicating, for example, “Do you want to view recommended photography points?”. When the user 5 selects a button of, for example, “YES”, the screen on the monitor 130 switches to a screen of FIG. 23B.

In FIG. 23B, the monitor 130 displays pieces of content selectable by the user 5. When there are too many pieces of content to be displayed on one screen, the user 5 can operate the controller 300 to scroll and switch the screen. When the user 5 selects, for example, a content number “1”, the screen switches depending on the selection result.

More specifically, in FIG. 23C, the monitor 130 displays a recommended content number “1”. When the user selects “play”, the selection result is transmitted to the computer 200, and the processor 210 starts to playback the content.

In FIG. 23D, when playback of the content ends, a screen for inducing input of a comment by the user 5 is displayed. The comment input by the user 5 is transmitted to the server 600. The server 600 stores the content in association with the comment. At a later date, when a new user views the same content, the server 600 may present accumulated comments to the new user. The new user can determine whether to take a photograph with reference to those comments. In at least one aspect, the screen is displayed during playback of the content. For example, the user 5 may temporarily stop playback of the content, and input a comment during the stop. With this, the user 5 may be prevented from failing to input a comment.

After that, in FIG. 23E, after the playback of the content, the monitor 130 displays a message, for example, “Thank you for viewing a recommended spot”.

[Summary]

As described above, according to at least one embodiment of this disclosure, the photography angle is determined first, and after that, the avatar enters a photographed image. The user 5 determines an angle (position of virtual camera 14) at which to take a photograph while visually recognizing content (panorama moving image) in the virtual space 11, and then obtains data on a timing of photographing the panorama moving image as to who desires to take a photograph at which position and at which time (or when the photograph was taken). Such data is different from data that is based on a two-dimensional photographed image obtained by taking a photograph in the real space.

After that, one or more users visually recognizing the same content can adjust arrangement of avatar objects corresponding to the one or more users and take selfies, to thereby obtain photographed images containing their own avatar objects. The server 600 may store information on arrangement positions of those avatar objects at photography angles.

The angle information (e.g., information indicating who took a photograph at which position at which time) is associated with the content ID, and is accumulated in the server 600 for each piece of content. As a result, the server 600 can recommend the angle information serving as a photography point to a new user for a location at which many users take a photograph. The server 600 can also recommend an angle that suits the preference of a user based on the accumulated information. When the user takes a photograph based on the recommendation, the photography result is transmitted to the server 600, and thus the server 600 accumulates in the database the preference of the user as to, for example, whether the user has taken a photograph at the angle based on the recommendation. When the user has used the angle that is based on the recommendation, the user can give a feedback to the server 600 by, for example, inputting an impression of using the angle. The server 600 can also store the location of arranging an avatar object at each angle for each piece of content, to thereby appropriately recommend, to a new user viewing the content, the arrangement of an avatar object of the user based on photography records of other users.

The server 600 can collect data indicating an interest of the user based on a subject shown in an image photographed by the user, and thus the server 600 can also distribute an appropriate advertisement to the user based on the data.

A Part of the Technical Features Disclosed Herein is Summarized in the Following Manner

(Configuration 1)

There is provided a program to be executed on a computer 200 to provide a virtual space 11, the program causing the computer 200 to execute: defining the virtual space 11 to be presented to HMD 120 connected to the computer 200; presenting, in the virtual space 11, a camera object 1541 for photographing an image to be displayed in the virtual space 11; receiving an operation for changing a position or posture of the camera object 1541 by a user 5 of the HMD 120; and storing position information representing the position of the camera object 1541 or posture information representing the posture of the camera object 1541.

(Configuration 2)

It is preferred that the presenting of the camera object 1514 include presenting the camera object 1541 based on an operation by the user 5 of the HMD 120.

(Configuration 3)

It is preferred that the program cause the computer 200 to further execute presenting, in the virtual space 11, a user interface object for receiving input of a comment by the user 5.

(Configuration 4)

It is preferred that the image contain a plurality of frames. Tag information inducing photography is associated with any one of the plurality of frames. The presenting of the camera object 1541 includes presenting the camera object 1541 when a frame with which the tag information is associated is presented in the virtual space 11.

(Configuration 5)

It is preferred that the tag information contain any one of information created in advance at a time of creation of an image and information associated with an image based on photography by the user 5 who has viewed the image.

(Configuration 6)

It is preferred that the program cause the computer 200 to further execute causing the camera object 1541 to take a photograph when the posture of the camera object 1541 has continued for a fixed period of time.

(Configuration 7)

It is preferred that the program cause the computer 200 to further execute arranging ao avatar object of the user 5 of the HMD 120 in the virtual space 11 and causing the camera object 1541 to photograph the avatar object.

(Configuration 8)

It is preferred that the storing of the position information and the posture information include storing position information and posture information on the camera object 1541 at a time of photographing the avatar object. The program causes the computer 200 to further execute storing position information representing a position of the avatar object and posture information representing a direction of the avatar object.

(Configuration 9)

It is preferred that the program cause the computer 200 to further execute storing identification data, position information, and posture information on photographed content.

(Configuration 10)

It is preferred that the program cause the computer 200 to further execute presenting the camera object 1541 in the virtual space 11 when the camera object 1541 is not presented in the virtual space 11.

(Configuration 11)

It is preferred that the presenting of the camera object 1541 include presenting the camera object 1541 of the user 5 of the HMD 120 based on position information and posture information on a camera object 1541 used by another user sharing the virtual space 11.

(Configuration 12)

It is preferred that the program cause the computer 200 to further execute: presenting a hand object corresponding to a hand of the user 5 of the HMD 120 in the virtual space 11; adjusting the position and posture of the camera object 1541 in accordance with a motion of the hand object that is based on an operation or motion of the user 5; and keeping a posture of the camera object 1541 even when the hand object is separated from the camera object 1541 after the posture of the camera object 1541 is kept for a fixed period of time.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

What is claimed is:

1. A method of providing a virtual space, the method comprising:
defining a first virtual space, wherein the first virtual space comprises a virtual viewpoint and a first camera object;
defining a first visual field in the first virtual space based on a position and posture of the first camera object;
generating a first visual-field image corresponding to the first visual field;
displaying the first visual-field image in the first camera object;
detecting a motion of a first head-mounted device (HMD) associated with a first user;
defining a second visual field in the first virtual space based on the detected motion and a position of the virtual viewpoint in the first virtual space, wherein the second visual field comprises the first camera object;
generating a second visual-field image corresponding to the second visual field; and
displaying the second visual-field image on the HMD.

2. The method according to claim 1, further comprising:
changing the position or posture of the first camera object in accordance with an operation by the first user;
changing position information representing the position or posture information representing the posture in accordance with an operation by the first user; and
storing the changed position information or posture information.

3. The method according to claim 2, further comprising:
detecting an elapsed period of time since the position or posture of the first camera object has been changed; and
storing the first visual-field image into a memory when the elapsed period of time has exceeded a threshold value.

4. The method according to claim 1, further comprising:
arranging the first camera object in the first virtual space so that the first user is prevented from visually recognizing the first camera object in the second visual-field image; and
enabling the first user to visually recognize the first camera object in the second visual-field image in accordance with an operation by the first user.

5. The method according to claim 1, further comprising:
playing back a 360-degree video in the first virtual space,
wherein the 360-degree video comprises a plurality of frames, and
wherein tag information is associated with any one of the plurality of frames; and
displaying the first camera object in the second visual-field image in accordance with playback of the one of the plurality of frames with which the tag information is associated.

6. The method according to claim 5, further comprising:
receiving operation information on an operation by a second user associated with a second virtual space different from the first virtual space,
wherein the 360-degree video is played back in the second virtual space,
wherein the second virtual space comprises a second camera object,
wherein a third visual field is defined based on a position and posture of the second camera object in the second virtual space in accordance with an operation by the second user,
wherein a third visual-field image corresponding to the third visual field is generated, and
wherein the operation information is used for identifying a position and posture of the second virtual camera at a time of generation of the third visual-field image; and
defining the one of the plurality of frames with which the tag information is associated based on the position and posture of the second virtual camera at the time of generation of the third visual-field image.

7. The method according to claim 6, further comprising:
receiving the operation information from the plurality of second users associated with the second virtual space;
counting a number of times the third visual-field image is generated in each of the plurality of frames; and
defining one of the plurality of frames with which the tag information is associated when the number of times has exceeded a threshold value.

8. The method according to claim 1,
wherein the first virtual space comprises an avatar corresponding to the first user, and
wherein the method further comprises defining the first visual field so that the first visual field comprises the avatar.

9. The method according to claim 7, further comprising:
storing, into a memory, position information representing a position of the first camera object and posture information representing a posture of the first camera object at a time when the first visual field comprising the avatar is defined;
storing, into the memory, position information representing a position of the avatar and posture information representing a posture of the avatar at the time when the first visual field comprising the avatar is defined; and
generating the first visual-field image based on virtual space data defining the virtual space, the position information and posture information on the first camera object, and the position information and posture information on the avatar.

10. The program according to claim 1, further comprising:
receiving operation information on an operation by a third user associated with the first virtual space,
wherein the 360-degree video is played back in the first virtual space,
wherein the first virtual space comprises a third camera object associated with the third user,
wherein a fourth visual field is defined based on a position and posture of the third camera object in the first virtual space in accordance with an operation by the third user,
wherein a fourth visual-field image corresponding to the fourth visual field is generated, and
wherein the operation information is used for identifying the position and posture of the third camera object at a time of generation of the fourth visual-field image; and
displaying the first camera object in the second visual-field image based on the position and posture of the third camera object at the time of generation of the fourth visual-field image.

11. The method according to claim 1,
wherein the first virtual space further comprises an operation object, and
wherein the method further comprises
detecting a motion of a part of a body of the first user in a real space;
moving the operation object in accordance with the detected motion;
determining that the operation object and the first camera object have touched each other based on a positional relationship between the operation object and the first camera object;
changing the position and posture of the first camera object in accordance with a motion of the operation object when the operation object and the first camera object are in contact with each other;
starting to count an elapsed period of time when the operation object and the first camera object are no longer in contact with each other; and
storing the first visual-field image into a memory when the elapsed period of time has exceeded a threshold value.
